(19) United States
(12) Patent Application Publication
(10) Pub. No.: US 2007/0078718 A1
(43) Pub. Date: Apr. 5, 2007

(54) System and method for monetizing internet usage

(75) Inventor: David Gorodyansky, Sunnyvale, CA (US)

Correspondence Address: SUGHRUE MION, PLLC, 401 Castro Street, Ste 220, Mountain View, CA, 94041-2007, US

(73) Assignee: ANCHORFREE, INC., Sunnyvale, CA (US)

(21) Appl. No.: 11/594,306

(22) Filed: Nov. 7, 2006

Related U.S. Application Data
(63) Continuation of application No. 11/471,247, filed on Jun. 19, 2006.
Application No. 11/471,247 is a continuation-in-part of application No. 11/291,442, filed on Nov. 30, 2005.
Application No. 11/471,247 is a continuation-in-part of application No. 11/291,688, filed on Nov. 30, 2005.
Application No. 11/471,247 is a continuation-in-part of application No. 11/292,187, filed on Nov. 30, 2005.
(60) Provisional application No. 60/683,441, filed on May 20, 2005.

(51) Int. Cl. G06Q 30/00

(52) U.S. Cl. 705/14

(57) ABSTRACT

Toolbar incorporating software that collects, analyzes and protects information on user preferences determined based on user's online activities. Advertising is targeted to each user, while user's privacy is protected by storing all personal information on user's local computer. The toolbar permits advertisers to advertise without paying fees until advertising brings actual revenue. The toolbar also provides means for giving incentives to users by allocating to users portion of generated revenue back to user. To this end, the toolbar may involve one or more of the following: web search engine interface with cost-per-action revenue model, web browsing monetization engine, advanced advertising engine and engine for tracking accumulated user's rewards. In one implementation, once advertiser generates revenue from displayed advertising material, percentage of generated revenue is provided back to users. The described concept is not limited only to toolbar and may be alternatively implemented as portal or in any other suitable platform.

### CROSS-REFERENCE TO RELATED PATENT APPLICATIONS

This patent application claims benefit of and is a continuation of U.S. patent application Ser. No. 11/471,247, filed Jun. 19, 2006, the entire disclosure of which is incorporated herein by reference. U.S. patent application Ser. No. 11/471,247 is a continuation in part of U.S. patent application Ser. No. 11/291,442, filed Nov. 30, 2005; U.S. patent application Ser. No. 11/291,688, filed Nov. 30, 2005; and U.S. patent application Ser. No. 11/292,187, filed Nov. 30, 2005, which claims benefit of U.S. Provisional Patent Application Ser. No. 60/683,441, filed May 20, 2005; the disclosures of which are incorporated herein by reference in their entirety.

### FIELD OF THE INVENTION

The present invention relates generally to Internet technology and more specifically to techniques for enabling targeted advertising of goods and services.

### DESCRIPTION OF THE RELATED ART

There exists at least several business models associated with the Internet commerce (e-commerce). Some models are simple. For example, a company may offer goods or services to customers via the web and collect revenues generated by the web sales. This model is called a generalized portal. The manufacturer or “direct model”, it is predicated on the power of the web to allow a manufacturer (i.e., a company that creates a product or service) to reach buyers directly and thereby compress the distribution channel. The manufacturer model can be based on efficiency, improved customer service, and a better understanding of customer preferences. The generated revenues are used for operating expenses of the business and to increase the capital. A good example of the generalized portal is Dell Computer corporation, which maintains a web portal www.dell.com.

In contrast to the aforesaid generalized portal model, which seeks to drive a high volume of traffic to one site, the affiliate model provides purchase opportunities wherever people may be surfing. It does this by offering financial incentives (in the form of a percentage of revenue) to affiliated partner sites. The affiliates provide purchase-point click-through to the merchant. It is a pay-for-performance model—if an affiliate does not generate sales, it represents no cost to the merchant. The affiliate model is inherently well-suited to the web, which explains its popularity. Variations include for example, banner exchange, pay-per-click, and revenue sharing programs.

The partner referral-based revenue sharing model operates in the following way. A referring website contains a link to the merchant partner website. When a user visiting a referring website uses the link to visit the merchant partner website, the referring website receives a payment from the merchant partner website in a specific fixed amount or receives a portion of the amount f money that the user spends on the merchant partner website. To enable the aforesaid revenue sharing model, the merchant partner website must be capable of distinguishing the online traffic originating from each or its partners. This is accomplished by using special partner URLs, which differ from the target website's main URL. Specifically, the aforesaid partner URL is modified in a such a way that includes the information on the referring partner website. In one example, the information identifying the partner is added to the main URL of the target website. Exemplary partner URLs include www.amazon.com/partner_name.

Unfortunately, the current technology limits the revenue sharing only to the web traffic originating on websites visited by the user prior to visiting the target website. Additionally, the end users of the existing systems do not have any incentive to participate in the aforesaid revenue sharing model. Therefore it would be desirable to have a system which would expand the aforesaid revenue sharing scope to other web traffic and to provide incentives to the end users to use the referring partner's website in searching for goods or services on the Internet.

### SUMMARY OF THE INVENTION

The inventive methodology is directed to methods and systems that substantially obviate one or more of the above and other problems associated with conventional techniques for monetizing web usage.

In accordance with one aspect of the inventive methodology, there is provided a computerized system, executing a web browser toolbar. The inventive toolbar includes a first user interface configured to receive a query from a user and to furnish the received query to a web search engine with a cost-per-action revenue model and a second user interface configured to receive a web address information from the user and to forward the received information to a web browsing monetization engine. The inventive toolbar further includes an advertising engine configured to display targeted advertising information to the user based on user's preferences and interest information. The user's preferences and interest information, the web browsing monetization engine and the advertising engine are co-located with the user.

In accordance with another aspect of the inventive methodology, there is provided a method and a corresponding computer programming product. In accordance with the inventive method, a first user interface is displayed to the user, the first user interface operable to receive a query from a user and to furnish the received query to a web search engine with a cost-per-action revenue model. Also in accordance with the inventive method, a second user interface is displayed to the user, the second user interface operable to receive a web address information from the user and to forward the received information to a web browsing monetization engine. The inventive method further involves executing an advertising engine configured to display targeted advertising information to the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an exemplary embodiment of an inventive toolbar.

FIG. 2 depicts a conceptual block-diagram of an embodiment of the inventive computerized search engine system.

FIG. 3 depicts an exemplary search results page generated by an embodiment of the inventive computerized search engine system.

FIG. 4 depicts a conceptual block-diagram of an inventive user URL redirection engine.

FIG. 5 depicts a conceptual block-diagram of an alternative embodiment of an inventive user URL redirection engine.

FIG. 6 depicts a conceptual block-diagram of an inventive DNS/Proxy/Redirector module;

FIG. 7 depicts an exemplary architecture of the inventive system having the functionality for enabling user location-specific advertising.

FIG. 8 shows an exemplary search results page displaying location-specific information generated by the inventive system.

FIG. 9 depicts an exemplary embodiment of the inventive system providing the aforementioned time functionality.

FIG. 10 depicts an exemplary location and time specific search results an embodiment of the inventive system.

FIG. 11A depicts a schematic diagram illustrating an embodiment of the inventive system, which utilizes information on user's interests and/or personal preferences.

FIG. 11B illustrates operation of the inventive toolbar and inventive filter software.

FIG. 12 illustrates an exemplary embodiment of a computer platform upon which the inventive content processing system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

One embodiment of the inventive concept is a toolbar, which permits the advertisers to advertise their products or services without paying fees or otherwise incurring the costs until the advertising brings actual revenue. The advertising is preferably displayed in the browser displayed on a computer screen or other similar device having web browsing capability. In addition, the advertising may be displayed in other similar application, such as an instant messenger or the like. The inventive concept also provides means for giving incentives to the user by allocating portion of the generated revenue or some kind of proportional reward back to the end user. To this end, the inventive toolbar may involve one or more of the following: a web search engine interface with a cost-per-action revenue model, a web browsing monetization engine, an advanced advertising engine and an engine for tracking the accumulated user's rewards. In one embodiment of the invention, once the advertiser generates revenue from the placed advertising material, a certain percentage of the generated revenue is provided back to the end user. It should be noted that the inventive concept is not limited only to a toolbar and may be alternatively implemented as a portal or any other suitable platform.

An embodiment of the inventive concept includes software, which tracks when advertisers generate revenue from each end user and allocates the generated revenue to the advertiser, the end user and the company providing the toolbar. Each inventive toolbar incorporates a unique ID and displays Cost Per Action ads, described in detail below, from which revenues are derived when purchases are made by users using the inventive toolbar technology. Pursuant to the inventive concept, the users are rewarded proportionally to their spending. In accordance with one aspect of the inventive methodology, advertisers are only charged when Internet users buy products or services or in any way derive revenue from the users. In other words, the inventive concept essentially eliminates the advertiser's risk. Specifically, in accordance with the inventive concept, the advertisers do not pay per impression or per click. On the other hand, the Internet users receive back a percentage of the money that they spend purchasing goods or services on any Internet websites that they visit while the browser application is executing on their browsers. In one embodiment, all of the functions described above are implemented within an inventive toolbar, which may be implemented to be a part of the user's web browser. Using the inventive toolbar, the Internet users can go to numerous eCommerce Internet portals without the need of first visiting the referring website and receive back a percentage of the amount of their every purchase.

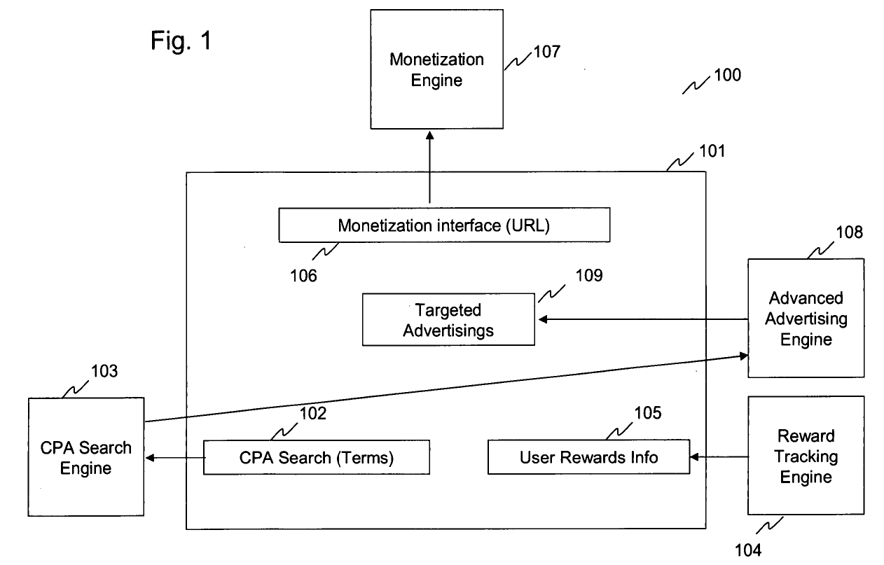

An exemplary embodiment of a layout of the inventive toolbar 100 is illustrated in FIG. 1. The inventive toolbar includes a viewable portion 101, which displays a web search engine interface 102 coupled with a search engine with cost-per-action revenue model 103. When the user inputs one or more search terms into the search engine interface 102, the interface passes the search terms to the engine 103. The engine performs a search of the Internet and displays the search results back to the user on the user's browser (not shown). The search engine also uses the browser window to display one or more sponsored ads to the user, based on the input search terms. When the user uses one of the displayed sponsored links to access the advertiser's website and generates revenue for the advertiser, the advertiser initiates a payment to the search engine operator, as described in detail below. In addition to generating the payment to the search engine operator, the advertiser may additionally provide payment to the end user, as will also be described in detail below. The amount of the payment (reward) to the end user is,determined and tracked by the engine for tracking the accumulated user's rewards 104. The rewards tracking engine 104 displays the reward balance to the user using the reward display 105.

The inventive toolbar further includes a monetization interface 106 coupled with the web browsing monetization engine 107. The monetization interface 106 receives URLs that the user wishes to view and supplies those URLs to the web browsing monetization engine 107. The engine, in turn, determines whether the URL(s) specified by the user correspond to any of the partner websites and, if so, re-writes the URL(s) to ensure that the user accesses the desired website(s) through the appropriate affiliate links. This triggers a payment from the accessed website to the provider of the inventive toolbar. A portion of that payment may be rebated to the user, as described in detail below. The rewards payable to the user are again tracked by the rewards tracking engine 104 and displayed to the user using the reward display 105.

The inventive toolbar further includes capability for users to exchange information, the ability to meet new people, and conduct social networking activities in their computer browser. To this end, the inventive system incorporates an instant messaging client to enable users to find other users and to network with one another. The inventive system's instant messenger receives location information form each computer's network card's IP address and allows users to find or locate people based on distance and location. Users of the inventive software can incorporate multiple or all instant messaging technologies into the inventive software and network with other users from the inventive browser software across multiple instant messaging platforms. Users with the inventive software can receive emails in their computer browser from multiple email platforms, accounts, and applications.

It should be noted that the inventive toolbar is not limited to any specific type of advertising materials. The inventive toolbar may display advertising materials that are not only generated by ad warehouses and cost per action merchants, but also by users and individuals creating personal ads for selling, buying, social networking, or other purposes.

An embodiment of the inventive toolbar may further include facilities enabling users to create and place ads within multiple inventive toolbars. The ads can be created not only by users with websites, but users without a website as well. Users can fill out a form that the ad will be linked to or link the ad to any personal portal. Ads do not need to be generated by businesses but can be generated by individuals with or without a website and targeted through out all user's with the inventive software in the inventive toolbar.

Finally, the inventive toolbar includes an advanced advertising engine 108, which displays the advertising materials 109 to the user based on the user's search preferences determined from user's prior searches, websites visited and links (URLs) clicked by the user, as well as geographic location of the user and/or the time of the day. The information about the user is preferably stored on the user's own computer to facilitate user's privacy. The location information may be derived from the user's Internet (IP) address. The user's preferences and other user information are stored on the user's computer for privacy and security reasons. It should be noted that the user's search preferences may be derived from the user's prior queries to the search engine 103, see FIG. 1. In addition, the search preferences may be derived from any website, search, or other action the users conduct online are all stored on the user's computer and analyzed automatically by a proprietary algorithm. As would be appreciated by those of skill in the art, no third party has access to that information and the ads are served in the toolbar based on prior online activities of the user.

Now, various components and aspects of the inventive methodology will now be described in detail with reference to FIGS. 1-12.

Search Engine Interface With Cost-per-action Revenue Model

The inventive search engine with a cost-per-action revenue model 103 enables the search engine operator to charge the advertisers who place their links on the search engine only if the user uses the search results to visit the advertiser's web portal(s) and generates revenue for the advertiser. This concept is especially attractive to the advertisers because it eliminates the risk, which the advertisers face in conventional search engines, when they are changed by the search engine per user click irrespectively of whether the user's visit resulted in advertiser's revenue.

In addition, an embodiment of the inventive system track's user's behavior and authorizes payments to the users based on the share of the revenue received from the content providers.

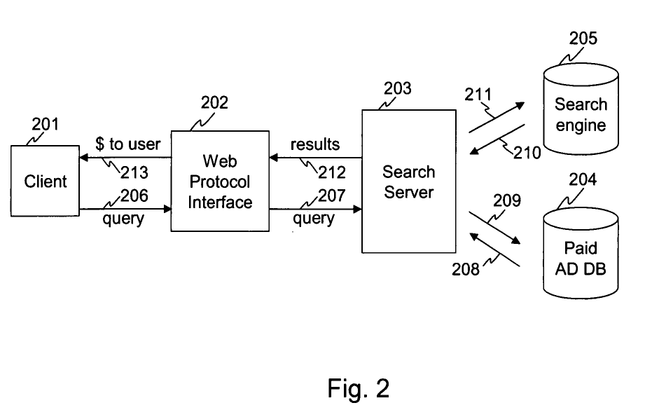

FIG. 2 illustrates an exemplary embodiment of the computerized internet search engine system in accordance with an embodiment of the inventive concept. In FIG. 2, a client 201, executing the inventive toolbar 100 sends a search query 206, 207 to the inventive search system 203 through its web protocol interface 202. The inventive search system 203 and its web protocol interface may be remote from the client 201. The web protocol interface may be implemented by means of a web server configured to receive, for example, http requests from clients. The search engine 203 performs the search of the internet content by accessing 210 the search engine 205, which may be one of the well-known search engines available on the Internet, including, without limitation, Google, Yahoo, MSN, Alta Vista, etc. The search engine 205 stores and indexes multiple web pages in its internal storage. After executing the query 207, the search engine 205 returns the query result 211 to the search system 203. The search system 203 receives the query results from the search engine 205 and integrates them with paid advertising materials that are stored in the paid advertising database 204. To this end, the search system 203 issues a query 209 to the paid advertising database 204 in order to identify the paid advertisements which best match the user's query 206. The search query results together with integrated advertisement materials 212 are sent by the search system 203 to the client 201 through the web interface 202. In another alternative embodiment of the inventive concept, the search system 203 itself integrates an internal search engine subsystem (not shown), which is used to execute user queries.

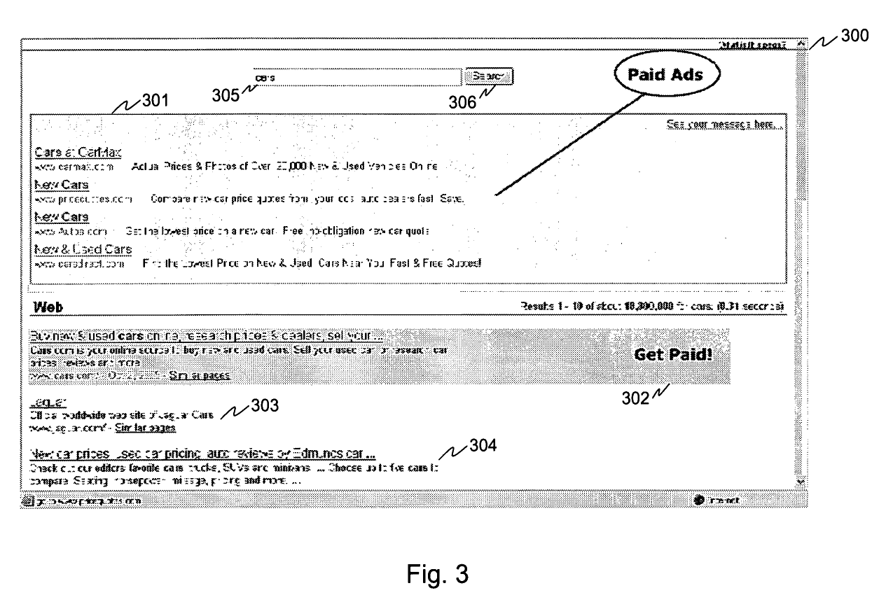

An exemplary embodiment of the search result page containing search query results together with integrated advertisement materials, designated in FIG. 2 by numeral 213 is depicted in FIG. 3. The depicted search result page includes “free”search results 303 and 304, which have been retrieved from the web. These results are also refereed to as “free” search results because they are not sponsored or paid for by an advertiser. The result 302 is an example of a sponsored result or link, which has been retrieved by the inventive search system from the paid advertisements database and inserted into the results page. If a user uses this link to access the advertiser website and makes a purchase, in accordance with the inventive concept, the advertiser authorizes a payment to the search engine operator. The exact mechanism for tracking the purchase transaction and recording the payment is not essential to the present invention. Specifically, the purchase may be detected by the advertiser's e-commerce system, which would also determine that the customer was sent to the advertiser's website by the inventive search engine. The purchase information may be then forwarded to the inventive toolbar 100. In another embodiment of the invention, the purchase is tracked by the inventive toolbar 100 and the purchase information is sent to the advertiser. Pursuant to this information, the payment may be recorded in an advertiser's database. The sponsor-paid advertisement is designated in search result page by numeral 302. Optionally, this page may contain the search term input field 305/306. Finally, the search result page may also include advertiser-sponsored links inserted by the search engine 205. Such links are not handled by the inventive search system and are designated with numeral 301. The advertiser-sponsored links 301 differ from links 302 in that they are fully prepaid by the advertiser and do not generate additional revenue for the search engine operator upon the user's purchase of goods or services.

The amount of the payment received by the operator of the inventive system from advertiser may have any predetermined relationship to the amount of revenue realized by the advertiser from the specific user visit. One example of such relationship may be a proportionate relationship or a certain percentage.

In an embodiment of the inventive system, portion of the payment received by the operator of the inventive search system from the advertiser is rebated back to the user. For this purpose, the user may be required to establish a user account to enable the inventive system to track user activities and to store information on the credit due the user. To implement this functionality, the inventive search system may additionally include a database system for storing user and payment information. As will be appreciated by those of skill in the art, such rebate system provides additional incentives for users to user the inventive system for searching. In an alternative embodiment of the invention all user and payment information is stored entirely on the user's own computer. The rebate (incentive) amount to the user using the inventive toolbar 100.

It will be appreciated by those of skill in the art, the inventive system is not limited to interoperating with only one advertiser or only one external search engine. In an embodiment of the inventive search system, the user may specify which external search engine should be used to retrieve the web search results.

Web Browsing Monetization Engine

When a user navigates to a web address by means of inputting a web address or clicking on a link resource in the inventive toolbar or web browser or by any other means, the web browsing monetization engine 107 of the inventive toolbar 100 operates to redirect the Internet user to the web resource requested by the user through appropriate affiliate links, triggering the invocation of the affiliate payment protocol.

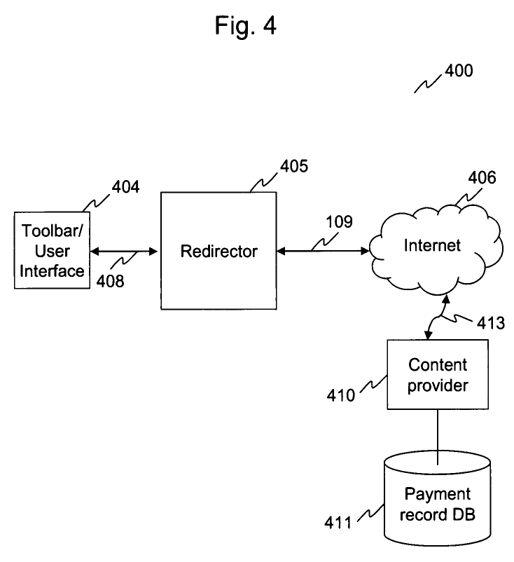

An exemplary embodiment of the web browsing monetization engine is shown in FIG. 4. The engine includes a user interface 404, which receives requests from the clients and forwards those requests to the Redirector 405, which monitors the user requests, determines if any of the user requests are directed to partner websites and, if so, redirects the matching user requests to the partner websites through appropriate affiliate links, triggering the appropriate payment routine. The Redirector 405 is located on the user's computer and may be a part of the inventive toolbar 100. To this end, the content provider 410 may have a payment records database 411, which is updated with a record specifying a payment to an affiliate, every time a user uses enters the content provider's website through the corresponding affiliate link. The content provider 410 makes periodic payments to its affiliates based on the information stored in the payment records database 411.

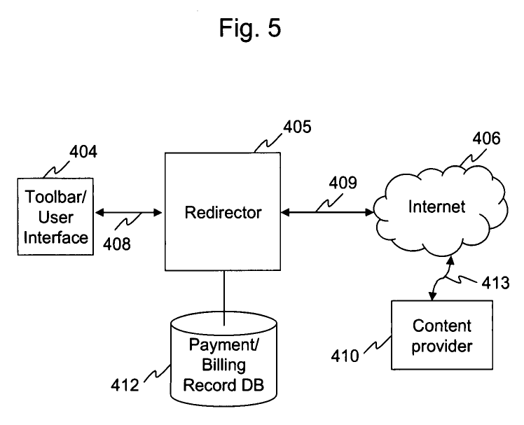

In an alternative embodiment, all the payment information may be stored in the inventive toolbar 100 and provided to the affiliate merchant/content provider periodically or upon request. In this embodiment, upon determining that the user requests to access a partner website, the inventive system redirects the user to the partner website through an appropriate affiliate link and generates a billing record to be sent to the partner content provider 410. For this purpose, an embodiment of the inventive system shown in FIG. 5 includes payment/billing record database 412, which stores all such records and resides locally, on the user's computer. The database 412 may be implemented as a database application executing on the user's computer or be implemented as an embedded database. All the other components and subsystems of the system shown in FIG. 5 are equivalent to the components of the system of FIG. 4, which are designated with the same numerals. In addition, the redirecting event could prompt the inventive system to record a credit to the appropriate internet service provider that hosted the requesting user. This credit information may also be stored in the payment/billing record database 412.

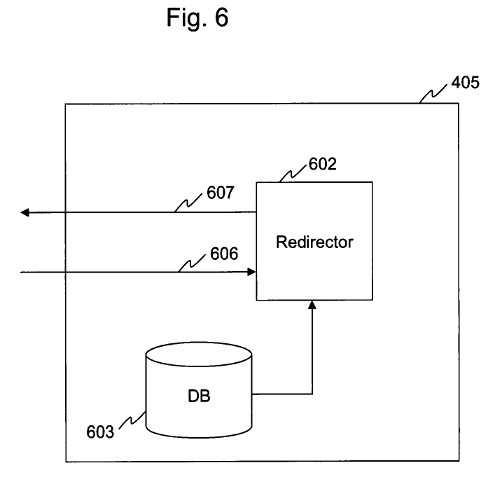

FIG. 6 illustrates an exemplary illustrative embodiment of the inventive Redirector module 405. This module intercepts requests 606 sent by the user through the inventive toolbar 100 and either simply transmits the requests without any modification or modifies the requests redirecting the user to the partner content provider through the designated affiliate links, thereby triggering the payment mechanism. The Redirector module intercepts the requests 606 from the toolbar 100. The Redirector application 602 examines the content of the request to determine whether the request involves one or more of the resources of an affiliate content provider. For this purpose, the Redirector module 405 includes a database 603, which stores information on the identity of the affiliate content providers, as well as redirection rules. The proxy application 602 makes queries to that database to retrieve the matching content provider information.

If the user request is not directed to the affiliated provider, as determined by the Redirector application 602, the Redirector simply forwards the request to its intended destination, see item 607. On the other hand, if the user request does contain matching partner information, the Redirector application 602 re-writes the request redirecting the user to the content provider through an appropriate affiliate link, retrieved from the database 603. The redirection information may be stored in the database 603. When users use the toolbar 100 to access participating content sites, the inventive software directs them through the partnership/affiliate link provided by the partners, thus generating revenue to the entity identified in the affiliate links utilized by the redirector module. Preferably, the identified entity is the maker of the inventive toolbar. When users go to non-participating sites the inventive software sends them through without monetizing the traffic.

Advertising Engine

The advertising engine 108 downloads on to each user's computer with the inventive toolbar or by any other means. The inventive software creates a secure and encrypted data file that stores information and algorithms that analyze and collect information seen on every site visited by the user, every search performed and every link clicked by the user. All of the collected information is analyzed for language elements and securely saved on the user's computer. In one embodiment the advertising engine does not send any information collected to any third parties central servers, rather it locally stores it on the user's computer analyzes the site the user is on and send relevant information based on past information collected to the toolbar or to any search engine, web page, or publisher to display relevant advertising. The whole process happens locally on the user's computer, and the advertisings displayed are different for each user. The advertising engine 108 embodies an improved algorithm for selecting paid advertisements, information, or content for inclusion with search results of an internet search engine and displaying the selected advertisements to the user, for modifying and personalizing/customizing web content, and any other customization of information. The inventive algorithm collects data related to each user, as well as other pertinent information and includes the collected personalized and customized data into search queries submitted to search engines, online TV or Radio, or any other content providers to modify and customize information/contenVads. The advertisements/information/content are retrieved based not only on search keywords input by the user, but also based on personal preferences, interests and demographics of the user, collected and stored on the user's computer as well as the location of the user and the time when the search is performed. In other words, the inventive technology enables each user to receive very targeted, localized and personalized advertising materials. The collected personalized data of the user is stored on the user's computer by the inventive software application 100.

The inventive software secures all information on the user's computer collected based on all of the user's searches utilizing all search engines, all websites visited, all information viewed. The software secures and encrypts all of the collected information on the user's computer and ensures that it is not available to third party servers or any party except for each specific user.

The functions of the inventive software are not limited only to automatically collecting information, but can be used for securing user provided information, such as financial data and other valuable personal information. In the case of financial data, a user can input financial personal data into the inventive software and make automatic online payments at participating online merchants. This enables payments to be processed on the user computer locally and transferred directly to a bank without providing sensitive financial data to the online merchant or any other third person. Thus, the data is secured from hackers and other forms of unauthorized access. Each user processes all financial and personal transactions locally on their computer using the inventive system.

One embodiment of the inventive system includes a software platform for identifying location of the user and the time of the usage. Additionally or alternatively, the inventive system may also contain functionality for collecting and storing personal information on each user and to store the collected information on that user's computer. When the user issues a search query to the search engine, the inventive system furnishes the time, location and/or user's personal information to the search engine in order to enable the search engine to achieve the most targeted advertising.

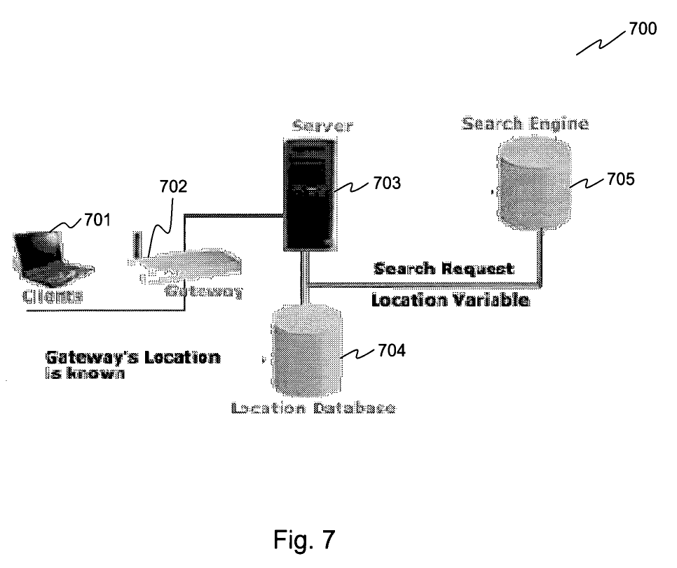

FIG. 7 depicts an exemplary architecture of the inventive system 700 having the functionality for enabling user location-specific advertising. The depicted system enables advertisers to add a location variable into their algorithms for retrieving targeted advertising materials. To this end, the inventive system shown in FIG. 7 has a capability to detect the origination point of the user's network traffic, which is determined and stored in the inventive toolbar 100. The inventive toolbar 100 feeds the location information for each Internet user into the search engine 705, which, in turn, provides customized advertising materials for each such Internet user taking into account the time and the user's location. The resulting advertisings may be city-specific, street-specific or even block-specific.

In order to determine the location information, the toolbar application reads the IP address of each computer's network card and matches the IP address to the location of the user. As well-known to persons of skill in the art, all Internet users are connected to routers on ISP networks and to gateways 702 on wireless Internet networks. In accordance with the inventive methodology, to determine the location of a user issuing a search engine query, IP address of each computer 701 utilized by the user is send to the inventive system. The inventive system checks the received IP address against its location database 704 associated with the server 703 to arrive at the user's location and feeds the user location data associated with each user search query into the search engine 705 configured to retrieve advertisings targeted to the specific location of the user, which may be city, street or block. In another embodiment of the invention, the user location may be determined from content of any website visited by the user.

Specifically, when user issues a query to a search engine containing one or more search terms, the query is received by the inventive system, which determines the current location of the user using the IP address associated with user's network connection. After the location of the user issuing query has been determined in the above-described manner, the inventive system adds a variable containing location information to the search request issued to the search engine, such that the operating algorithm of the search engine 705 uses the modified search request to perform its search.

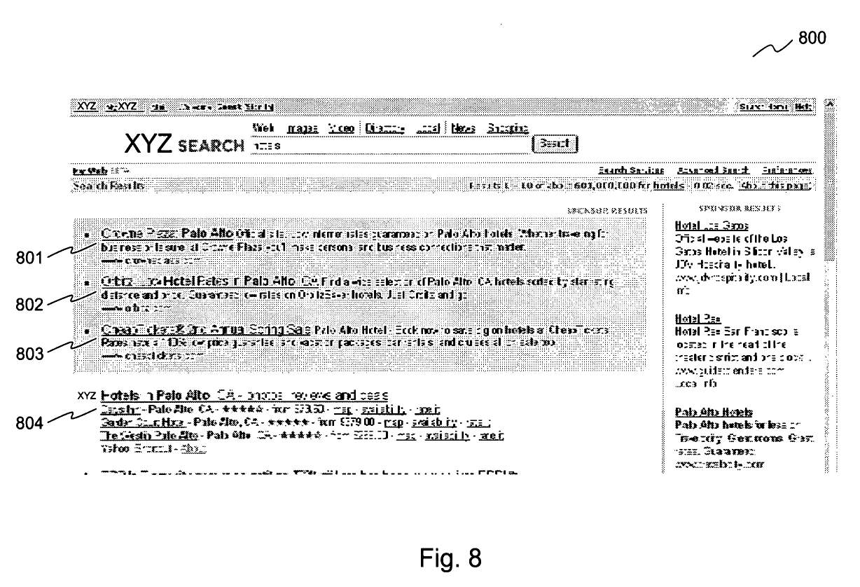

For example, in an embodiment of the inventive system, if a user sitting in a cafe in downtown Palo Alto, Calif., issues a query to a search engine seeking information on hotels, the inventive system would use the user's IP address information to detect the user's present location and subsequently rewrites the user's search engine query changing it from “hotels” to “hotels+palo+alto”. A search engine algorithm would then receive the location information as a part of the search query and would then return relevant location-specific results to the user. FIG. 8 shows an exemplary search results page 800 displaying location-specific information 801-804 generated by the inventive system.

Exemplary embodiments of search engines which are well known in the art include, without limitation, Google, Yahoo, Alta Vista, etc. The search engine may use its own technology to return the local search results to clients, based on the location feed from the inventive system through the modified query.

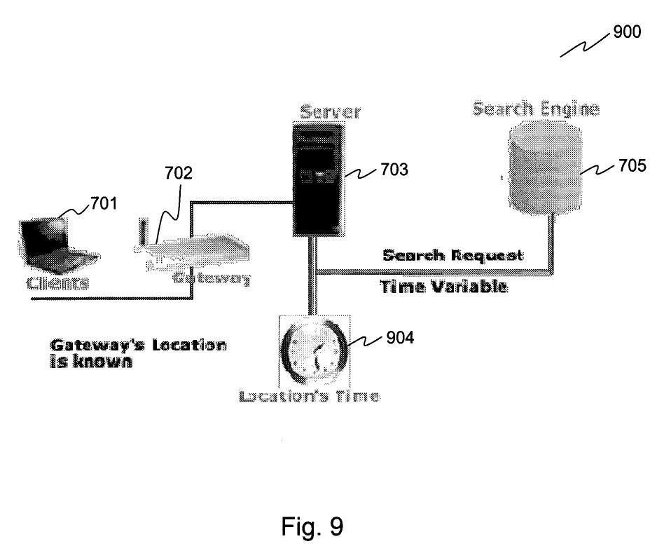

In addition to, or as an alternative to the location information, another aspect of the inventive technology enables advertisers to add current time information to the search algorithm. When a user connected to the Internet through a network of Internet Service Providers and Wireless Internet Service Providers conducts a search using a specific search engine, the inventive software automatically furnishes the local time information to the advertiser, which may be used singly, or in combination with the location information in formulating new search engine query. Thus, the results provided by the search engine may be both location and time specific. FIG. 9 depicts an exemplary embodiment of the inventive system 900 providing the aforementioned time functionality. Specifically, the depicted embodiment includes software module 904 for supplying local time at user's location and inserting this time information into the query issued to search engine 705. The remaining elements of the system depicted in FIG. 9 are similar for the corresponding elements of FIG. 7.

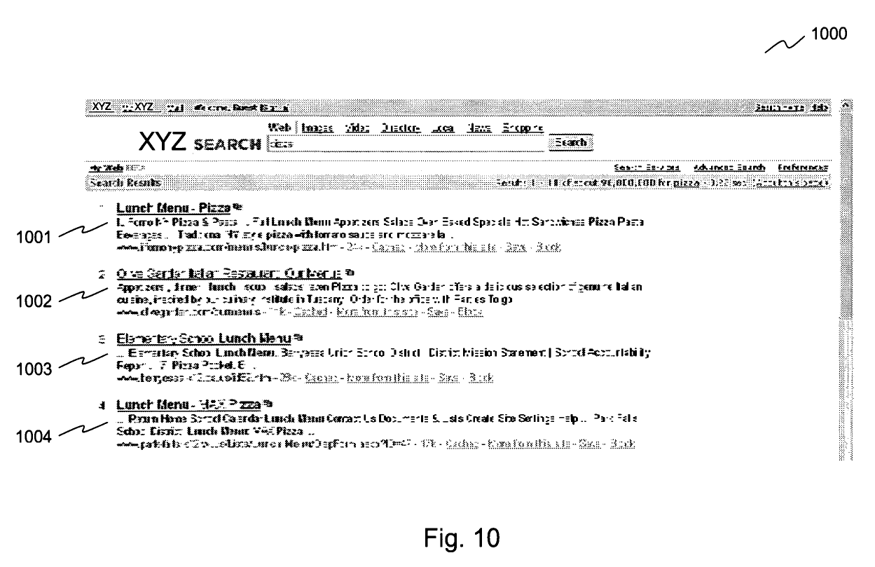

For example, when a user who is located in downtown Palo Alto, Calif., which is in Pacific time zone, searches for a pizza during a lunch hour, inputting keyword “pizza” into a search engine, the inventive system rewrites the user's query using the relevant location and time information. Such rewritten query may look, for example, similar to “pizza+palo+alto+1:30pm”. The search engine algorithm, after receiving the above search information, would provide relevant results for pizza places in Palo Alto, Calif., during lunch time. An exemplary location and time specific search results 1001-1004 generated by the described embodiment of the inventive system are shown (1000) in FIG. 10.

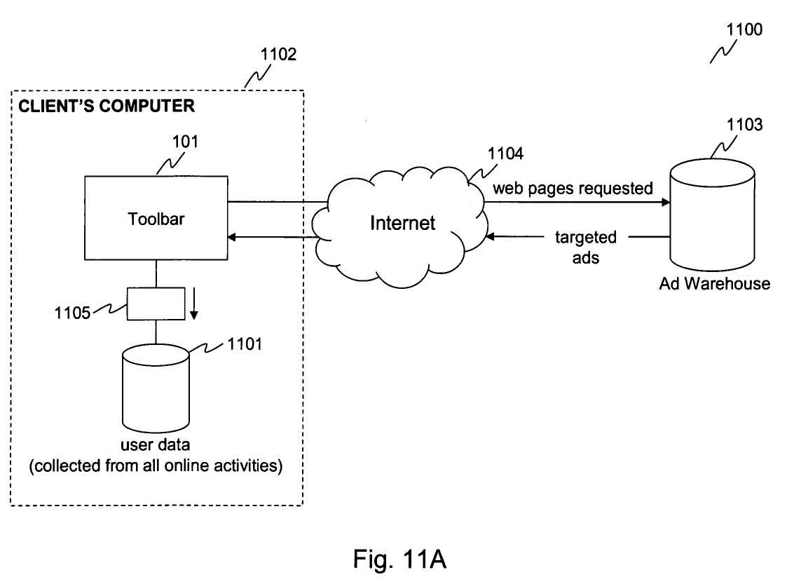

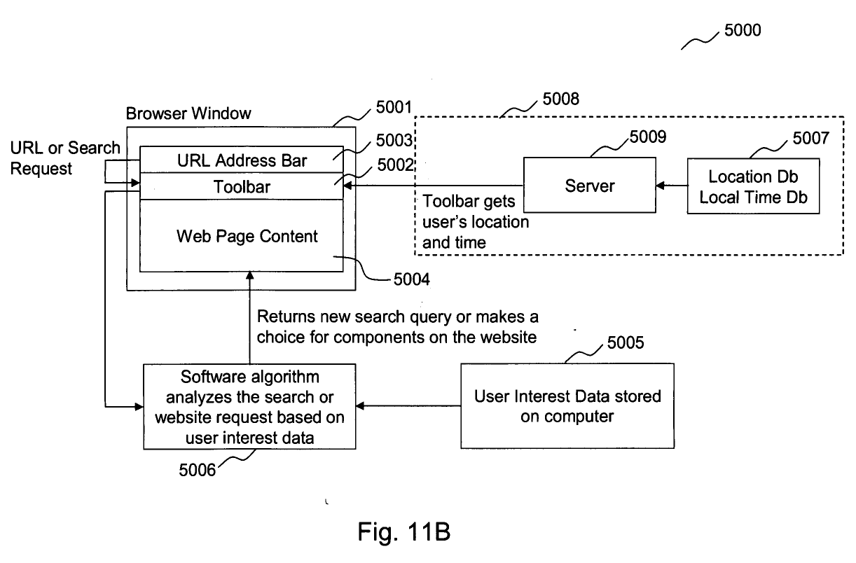

Another embodiment of the inventive technique inserts information on user's interests and/or personal preferences to each search query issued by the user. When a user performs an Internet search using the inventive system, the inventive system automatically filters out advertising information that is not likely to be of value to the user thus enabling advertisers to present to the user only relevant results. In one embodiment of the inventive concept, the information on interests and preferences of the user is systematically collected by the inventive system and stored on the user's computer. In addition, the inventive system may collect, store and use user's demographic information. FIG. 11A depicts a schematic diagram illustrating the aforementioned embodiment of the inventive system 1100 which uses information on user's interests and/or personal preferences. As would be appreciated by those of skill in the art, in the depicted embodiment, the user interest data 1101 is stored in the user's computer, which is designated by numeral 1102.

The embodiment of the inventive system depicted in FIG. 11A operates in the following manner. A user queries a search engine (not shown) for a term. The query is received by the inventive filter system software 1105 residing on the user's computer 1102, which checks the identity and demographics of the user based on the information 1101 stored on user's computer 1102. After the inventive filter software obtains the identity and demographics of the user, it analyses the received information and determines the likely preferences of the user. The user's likely preferences may be derived from the historical information on user's prior on-line activities, which is collected and stored by the inventive system. The advertisings selected based on the user's preferences are provided by the ad warehouse 1103 via internet 1104 and are displayed to the user.

The following description, together with FIG. 11B, provides additional details on operation of the filter and data mining and information security/privacy system software 5000, which may include an inventive toolbar 5002, and the user interest database 5005. It should be noted that the inventive toolbar 5002 as well as other inventive software may be used in conjunction with any browser application 5001 installed on any computer platform, including, without limitation, Internet Explorer, Firefox, Netscape, etc. for either PC or MAC computers. The toolbar 5002 described herein may be a proprietary toolbar or, in the alternative, the inventive software can be incorporated into any existing toolbar, including, without limitation, Yahoo, Google, and MSN toolbars.

When a user inputs a request for a webpage into a URL address field 5003 of a browser 5001 or sends a search query to a search engine, the inventive toolbar 5002 intercepts the user's request and forwards it to the inventive software 5006. User's location and local time are obtained by the local system using any techniques such as reading the computer network card. Both user's location and time are sent to the inventive software program for processing. For Example, the location and time can be obtained from an external system 5008, which may incorporate server 5009 and database 5007.

The inventive software algorithm 5006 analyzes the user-specified URL or a search request, as well as information on user's interests 5005, which is based on user's prior online activities stored on user's computer in the database structure or the like. If user's prior activities associated with this new request are found, the most frequently used activity is returned and its priority is incremented. The new modified query is then used to retrieve a website or to perform a search, modify content, display customized information.

For example, if a user located in Palo Alto, Calif., is searching for “used cars” using a search engine for the first time, the inventive toolbar sends the request to the inventive software. If the software algorithm does not find any associated activities related to “cars” or “used cars”, then only the location is added to the “used cars” query and the modified query “used cars +Palo Alto, Calif.” gets sent to a search engine the search results. Each “used” and “cars” get their indexes incremented by one. The database may look like cars[1], used[1].

When, subsequently to the aforesaid first search, the same user searches for “Nissan Maxima”, the inventive software algorithm queries the local database on the user's computer of previous user activities for activities associated with “Nissan Maxima”. If an entry “used cars” is found in the database, the inventive software modifies the user query to become “used Nissan Maxima cars”, which is subsequently sent to a search engine, a web page, or any other online resource. Indexes are incremented for terms cars[2], used[2], nissan[1] and maxima[1] and the corresponding entries are added to the database.

The information on the user's preferences is subsequently added by the inventive system to the query string issued to the search engine, such that the search engine algorithm uses the added preference information to perform the search. For example, if a user searches for cars and the inventive system determines, based on user's prior online activities, that the user is likely to prefer Nissan cars over other car makes, then the inventive system would change the user's query from “cars” to “cars+nissan”. A search engine algorithm would then receive and additional search term reflecting the likely preference of the user and return the relevant results.

Described above was the inventive process for modifying user's query, wherein the query is re-written by the inventive system and sent to the Ad Warehouse 1103, media company, a search engine, or any online resource. In another, alternative embodiment of the invention, the inventive filter software 1105 processes user requests and websites to display customized and targeted results to the user. For example, a web site like Yahoo can have multiple advertisers for its front page. The inventive filter algorithm allows Yahoo to expose advertisers targeted to each user by their previous online interests, websites visited, and/or action performed. If Nissan, BMW, and Ford all desire to advertise on Yahoo, the inventive filter software processes a data file on each user's computer where all visited URLs and visited content is stored, the inventive algorithm filters this information based on user's interests. In this manner, the inventive algorithm determines which of the multiple available advertisers Yahoo should expose to which user. If user Joe likes BMW, then, when visiting Yahoo.com, the inventive system enables the user to be shown BMW advertising on the front page instead of a Nissan or any other brand. It should be noted that, in an embodiment of the inventive system, the data file of collected user preferences and interests stored on the user's computer is never sent to any central server of any website or other third party. In the example above, Yahoo.com would sent the key words “Nissan” “BMW” “Ford” to each computer that has the inventive software, and the inventive software would see if there is a match in the file on the user's computer. If the user had looked at “BMW” before, the algorithm with select “BMW” and will send it to Yahoo as a hint. Essentially, the inventive software acts like a security guard to all information about each user's interest, and acts as an alternative to storing user interests on a central server. The information can be used either to display more relevant ads in the inventive toolbar or to modify ads for websites that want to display information, content, or advertising more relevantly and customized for each user.

To be able to interoperate with the inventive filter software and to enable this software to perform user activity customization, any affiliated web entities, including, without limitation, search engines, publishers, media companies, ad warehouses, may modify their respective code. Specifically, a special code may be included within the home page html code that would provide information to the inventive filter on available options. By way of an example, this additional code may be in the following form: <ads><option value=“nissan” url=“url1”><option value=“bmw” url=“url2”><option value=“ford” url=“url3”></ads>, wherein the “url1” and “url2” are internet addresses where the advertisements may be retrieved from.

In the above example, while processing the Yahoo homepage, the inventive toolbar sends a request for Nissan, BMW and Ford to determine which brand is of the most interest to the user. If the determination is made, then the appropriate URL is invoked to display the corresponding advertisement. For example, if Nissan is found to be more interesting for the user, “url1” is used.

As it would be appreciated by those of skill in the art, an embodiment of the inventive system, wherein the user preference information is held on user's own computer is advantageous because of enhanced privacy protection of the user's information.

It should be noted that the present invention is not limited solely to inclusion of location, time and/or user preference information into a search engine query. Such information may also be included with user's request for any network resource, including requests for specific internet resources, such as web pages, advertisements, commercials, local and national online newspapers, video/music, online TV, online radio or other Internet content.

For example, an embodiment of the inventive system can be used for providing online Internet television commercials or online radio commercials to users by customizing commercials to each user based on the user's interests collected and stored on each user's computer. Thus different people might see or hear different advertisements while watching online TV or listening to online radio all advertising is modified to each user using the inventive software.

In an embodiment of the inventive methodology, when an Internet user connects to the Internet and begins to browse the web pages, the inventive software algorithm automatically analyzes and stores on each user computer all information, links, searches, and websites. At any point in time when a user conducts a search or when advertisings are displayed to the user in response to user's requests for Internet resource, the additional information related to the user is added to the appropriate search query, resource request or otherwise sent to the advertiser. The advertiser, in turn, responds by providing relevant advertising materials to the user.

An aspect of the inventive methodology enables advertisers to display their advertisings even on the websites that are not affiliated with the advertiser. The inventive toolbar executing in conjunction with a web browser displays advertisings related to the content displayed on the main browser page. Specifically, every time a webpage is requested by a user running the inventive software, the toolbar displays advertising on every page viewed. The toolbar may incorporate the inventive software and display relevant advertisings on all websites that the user visits. The inventive software selects the advertisements for display based on the displayed content as well as preferences of the user, and in some cases location and time as described hereinabove.

Engine for Tracking Accumulated User's Rewards

The inventive toolbar additionally includes an engine for tracking the rewards accumulated by the user. The engine consists of the rewards and billing module and a database. The rewards and billing module saves information on the user online activities and the associated billing information into the database.

Exemplary Computer Platform

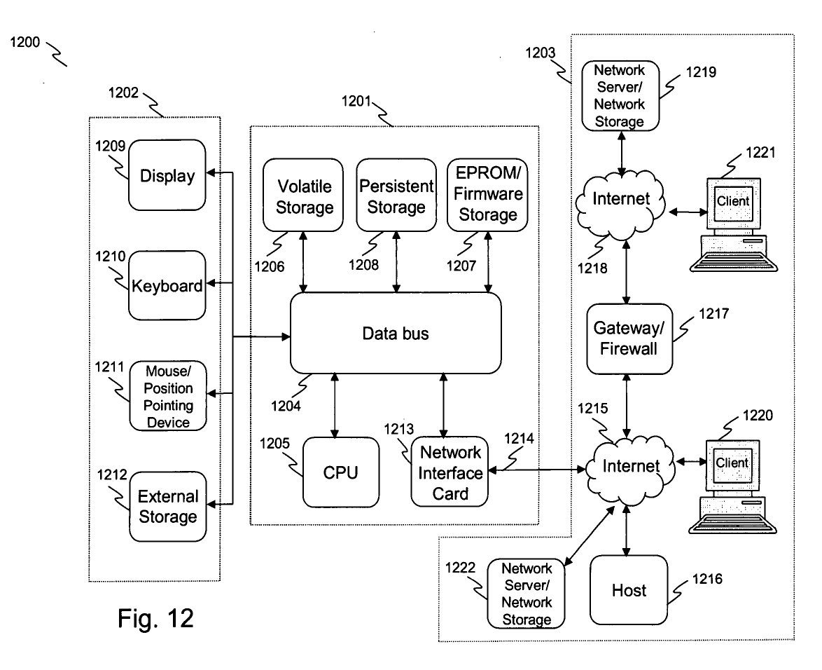

FIG. 12 is a block diagram that illustrates an embodiment of a computer/server system 1200 upon which an embodiment of the inventive methodology may be implemented. The system 1200 includes a computer/server platform 1201, peripheral devices 1202 and network resources 1203.

The computer platform 1201 may include a data bus 1204 or other communication mechanism for communicating information across and among various parts of the computer platform 1201, and a processor 1205 coupled with bus 1201 for processing information and performing other computational and control tasks. Computer platform 1201 also includes a volatile storage 1206, such as a random access memory (RAM) or other dynamic storage device, coupled to bus 1204 for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device coupled to bus 1204 for storing static information and instructions for processor 1205, such as basic input-output system (BIOS), as well as various system configuration parameters. A persistent storage device 1208, such as a magnetic disk, optical disk, or solid-state flash memory device is provided and coupled to bus 1201 for storing information and instructions.

Computer platform 1201 may be coupled via bus 1204 to a display 1209, such as a cathode ray tube (CRT), plasma display, or a liquid crystal display (LCD), for displaying information to a system administrator or user of the computer platform 1201. An input device 1210, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209. This input device typically has two degrees of freedom in two axes, a first axis (e.g., x) and a second axis (e.g., y), that allows the device to specify positions in a plane.

An external storage device 1212 may be connected to the computer platform 1201 via bus 1204 to provide an extra or removable storage capacity for the computer platform 1201. In an embodiment of the computer system 1200, the external removable storage device 1212 may be used to facilitate exchange of data with other computer systems.

The invention is related to the use of computer system 1200 for implementing the techniques described herein. In an embodiment, the inventive server 103 may reside on a machine such as computer platform 1201. In an embodiment, the location database 104 may also be deployed on a machine such as computer platform 1201. According to one embodiment of the invention, the techniques described herein are performed by computer system 1200 in response to processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1208. Volatile media includes dynamic memory, such as volatile storage 1206. Transmission media includes coaxial cables, copper wire and fiber optics, including the wires that comprise data bus 1204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1205 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The computer platform 1201 also includes a communication interface, such as network interface card 1213 coupled to the data bus 1204. Communication interface 1213 provides a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1213 sends and receives electrical, electromagnetic or optical signals that carry digital data streams representing various types of information.

Network link 1213 typically provides data communication through one or more networks to other network resources. For example, network link 1214 may provide a connection through local network 1215 to a host computer 1216, or a network storage/server 1217. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1215 and/or the Internet 1218. The network clients 1220 and 1221 may themselves be implemented based on the computer platform similar to the platform 1201.

Local network 1215 and the Internet 1218 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

It should be noted that the present invention is not limited to any specific types of wireless or wired network protocols. The requisite network configuration may be achieved using a variety of known networking protocols.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized monetization system. It is intended that the specification and examples be considered as exemplary only, with a true scope and spirit of the invention being indicated by the following claims.

What is claimed is:

1. A computer-implemented method for handling of user data, the method comprising:
a. Collecting the user data based on activities of a user across multiple domains;
b. Storing the collected user data on a computer of the user;
c. Protecting the stored collected user data from external access; and
d. Utilizing at least a portion of the user data in response to a request from the user.

2. The method of claim 1, wherein the user request comprises an HTTP request specifying a URL.

3. The method of claim 2, wherein utilizing comprises generating user interest information based on the stored collected user data and forwarding the generated user interest information together with the HTTP request.

4. The method of claim 1, wherein the user request comprises a search engine query.

5. The method of claim 4, wherein utilizing comprises generating user interest information based on the stored collected user data and forwarding the generated user interest information together with the search engine query.

6. The method of claim 1, wherein utilizing comprises generating user interest information based on the stored collected user data and forwarding the generated user interest information to an external entity.

7. The method of claim 1, wherein the protecting comprises encrypting the stored collected user data.

8. The method of claim 1, wherein utilizing comprises determining likely user preferences based on the stored collected user data and using the determined likely user preferences to select an advertising material for display to the user from a plurality of advertising materials.

9. The method of claim 8, wherein the selection is performed on the computer of the user.

10. The method of claim 1, wherein the activities of the user comprise visiting URLs.

11. The method of claim 1, wherein the activities of the user comprise search engine queries.

12. The method of claim 1, wherein the activities of the user comprise content accessed by the user.

13. The method of claim 1, wherein utilizing comprises automatically customizing advertising, information or content for each user on the fly, based on the stored collected user data and variables relating to the advertising, information or content.

14. The method of claim 13, wherein the advertising, information or content are customized by participating websites and are different for each user.

15. The method of claim 1, wherein utilizing comprises showing information to the user, the shown information being based on the on the stored collected user data.

16. A method for handling of collected user data, the method comprising:
a. Identifying the collected user data based on activities of a user across multiple domains;
b. Storing the collected user data on a computer of the user;
c. Protecting the stored collected user data from external access; and
d. Utilizing at least a portion of the user data in response to a request from the user.

17. The method of claim 16, wherein the user request comprises an HTTP request specifying a URL.

18. The method of claim 17, wherein utilizing comprises generating user interest information based on the stored collected user data and forwarding the generated user interest information together with the HTTP request.

19. The method of claim 16, wherein the user request comprises a search engine query.

20. The method of claim 19, wherein utilizing comprises generating user interest information based on the stored collected user data and forwarding the generated user interest information together with the search engine query.

21. The method of claim 16, wherein utilizing comprises generating user interest information based on the stored collected user data and forwarding the generated user interest information to an external entity.

22. The method of claim 16, wherein the protecting comprises encrypting the stored collected user data.

23. The method of claim 16, wherein utilizing comprises determining likely user preferences based on the stored collected user data and using the determined likely user preferences to select an advertising material for display to the user from a plurality of advertising materials.

24. The method of claim 23, wherein the selection is performed on the computer of the user.

25. The method of claim 16, wherein utilizing comprises automatically customizing advertising, information or content for each user on the fly, based on the stored collected user data and variables relating to the advertising, information or content.

26. The method of claim 16, wherein the advertising, information or content are customized by participating websites and are different for each user.

27. The method of claim 16, wherein utilizing comprises showing information to the user, the shown information being based on the on the stored collected user data.

28. A computerized system comprising:
a. A central processing unit operable to cause collection of user data based on activities of a user across multiple domains; and
b. A memory unit operable to store the collected user data, wherein the central processing unit is further operable to protect the stored collected user data from external access and utilizing at least a portion of the user data in response to a request from the user.

29. A computer-readable medium embodying a set of computer instructions, which, when executed by one or more processors cause the one or more processors to:
a. Collect user data based on activities of a user across multiple domains;
b. Store the collected user data on a computer of the user;
c. Protect the stored collected user data from external access; and
d. Utilize at least a portion of the user data in response to a request from the user.
